(19) United States
(12) Patent Application Publication
(10) Pub. No.: US 2013/0111859 A1
(43) Pub. Date: May 9, 2013

(54) DESIGN AND SHAPE FOR PULSE CARTRIDGES TO ALLOW HYDROPHOBIC MEDIA TO DRAIN AND GENERALLY INCREASE WORKING SURFACE AREA

(71) Applicant: Paul Sherwood Bryant, Amesbury (GB)

(72) Inventor: Paul Sherwood Bryant, Amesbury (GB)

(73) Assignee: General Electric Company, Schenectady, NY (US)

(21) Appl. No.: 13/292,242

(22) Filed: Nov. 9, 2011

(51) Int. Cl. B01D 46/52; F02C 7/04; B01D 46/02

(52) U.S. Cl. 55/385.1; 55/521; 55/501; 55/498

(57) ABSTRACT

A filter element is provided for filtering air in an inlet system of a gas turbine. The filter element includes a hydrophobic filter media that limits the passage of particulates and liquid from passing through the filter element. The filter media extends along a longitudinal axis and circumferentially about a central passageway that extends along the longitudinal axis. The filter media further includes a plurality of pleats. The pleats extend in a non-linear or helical orientation about the longitudinal axis. Adjacent pleats define a trough portion extending therebetween. The orientation of the pleats reduces liquid from accumulating and pooling within the trough portion and promotes drainage of the liquid from the filter element.

### BACKGROUND OF THE INVENTION

1. Field of the Invention

The invention relates to a filtering device and, more particularly, to a hydrophobic filtering device that reduces an accumulation of liquid on the filtering device.

2. Discussion of Prior Art

Inlet systems for gas turbines are generally used for treating air that passes to the gas turbine. The air can be treated by filtering the air with one or more filter elements extending generally horizontally within the inlet system. Each filter element may include a pleated hydrophobic media that can simultaneously limit the passage of particles and liquid through the pleated hydrophobic media. However, liquid can accumulate on an outer surface of the pleated hydrophobic media. Specifically, liquid can pool in trough portions between adjacent pleats at a top surface of the filter element. Due to the substantially horizontal orientation of the filter elements, liquid is limited from draining from the trough portions, thus reducing air flow through portions of the filter element. As a result, this liquid accumulation can reduce the efficiency of each filter element by decreasing the effective filtering surface area. Furthermore, liquid accumulation can cause a large pressure drop across the filter element and excessive wear at the top surface of the filter element. Accordingly, it would be useful to provide a filter element that allows for liquid to drain from the filter element. Additionally, it would be useful to provide a device to solve the aforementioned problem without a major modification in the overall design of the filter elements.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect, the present invention provides a filter element comprising a filter media extending along a longitudinal axis and circumferentially about a central passageway that extends along the longitudinal axis. The filter media is configured to have a plurality of pleats, wherein the pleats extend in a helical orientation about the longitudinal axis.

In accordance with another aspect, the present invention provides a filter element comprising a support device extending circumferentially along a longitudinal axis about a central passageway and a filter media positioned on the support device and extending along the longitudinal axis circumferentially about the central passageway, the filter media being configured to have a plurality of pleats, wherein at least one of the pleats extends in a non-linear orientation about the longitudinal axis.

In accordance with another aspect, the present invention provides a filter element comprising helically oriented pleats, the filter element further comprises a filter media extending along a longitudinal axis and circumferentially about a central passageway that extends along the longitudinal axis, the filter media being configured to include the helically oriented pleats, the pleats extending in a helical orientation about the longitudinal axis, wherein the longitudinal axis extends along a substantially horizontal direction within a gas turbine system.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematized cross-section view of an example inlet system including an example filter element in accordance with an aspect of the present invention;

FIG. 2 is a perspective view of the example filter element including an example partition in accordance with an aspect of the present invention;

FIG. 3 is a sectional view of the example filter element along line 3-3 of FIG. 2;

FIG. 4 is a perspective view of the example filter element with a support device removed; and

FIG. 5 is a perspective view of an example of a prior art filter element with a support device removed.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

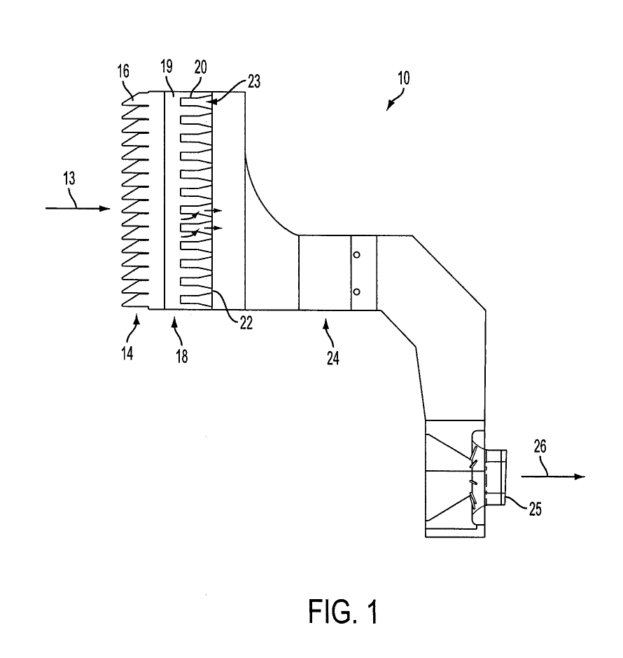

FIG. 1 illustrates an example inlet system 10 for delivering an air flow to a device, such as a gas turbine, according to one aspect of the invention. An entering air flow 13 can be drawn from an exterior location and into the inlet system 10. The entering air flow 13 can enter a filter section 18 and pass through one or more filter elements 20. The air flow can be filtered by the filter elements 20 before passing through an outlet section 24 and exiting through an outlet 25.

The inlet system 10 can include an inlet section 14. It should be appreciated that the inlet section 14 is somewhat generically shown within FIG. 1. This generic representation is intended to convey the concept that the inlet section 14 of the inlet system 10 shown in FIG. 1 can represent a prior art construction or a construction in accordance with one or more aspects of the present invention as will be described below. The inlet section 14 can be positioned at an upstream location of the inlet system 10. The inlet section 14 can define an open area through which the entering air flow 13 can enter the inlet system 10.

The inlet section 14 can include one or more hoods 16. The hoods 16 can provide a shielding function to help protect the inlet system 10 from ingesting at least some materials and/or precipitation that may otherwise enter the inlet section 14. Examples of such materials that the hoods 16 can shield from ingestion can include, but are not limited to, leaves, branches, animals, dust, particulates, etc. The hoods 16 extend outwardly from the inlet section 14. Of course, the hoods 16 are not limited to the shown example, and can take on a number of different sizes, shapes, and configurations. Moreover, the hoods 16 can be designed to withstand some amount of impact force from the materials and/or precipitation. For example, the hoods 16 can withstand heavy precipitation, such as a heavy rain, wind, or snow accumulation, without breaking while still reducing the amount of precipitation that enters the inlet section 14.

The example inlet system 10 can further include a filter section 18 positioned adjacent to, and downstream from, the inlet section 14. The filter section 18 can be in fluid communication with the inlet section 14, such that the filter section 18 can receive the entering air flow 13 from the inlet section 14. The filter section 18 defines a chamber 19 that includes a substantially open area. The chamber 19 can be substantially hollow such that air can enter and flow through the chamber 19.

The filter section 18 can further include one or more filter elements 20 positioned within the chamber 19. The filter elements 20 are shown to extend substantially horizontally within the filter section 18 and can be arranged in a vertically stacked orientation (i.e., one filter element above another filter element). However, in other examples, the filter elements 20 can be arranged in a vertically staggered position, such that a filter element 20 is not positioned directly above or below an adjacent filter element. The filter elements 20 can be positioned adjacent a bottom wall of the filter section 18 at a lower location. The filter elements 20 can be substantially evenly spaced apart from adjacent filter elements in the vertically stacked orientation upwards towards a top wall. In further examples, the filter elements 20 may not be evenly spaced apart in the vertical direction, such that some filter elements are closer or farther apart from adjacent filter elements than others. Similarly, the filter elements 20 can be arranged to be horizontally spaced apart, such that the filter elements 20 can extend across the filter section 18 in a column-like formation. It is to be understood that the filter elements 20 are only generically shown, and that the inlet system 10 could include a greater or fewer number of filter elements than in the shown example.

The filter elements 20 can each be attached to a partition 22 that is positioned at a downstream location of the filter section 18. The partition 22 can include a substantially vertically oriented wall that extends across the filter section 18 in a direction substantially perpendicular to an air flow direction. Specifically, the partition 22 can extend from the bottom wall towards the top wall and between opposing side walls of the filter section 18. The partition 22 can include a substantially non-porous structure, such that air flow is reduced and/or prevented from flowing through the partition 22. The partition 22 can further include one or more apertures 23 extending through the partition 22. The apertures 23 define openings through which the air flow can exit the filter section 18. As such, each of the filter elements 20 can be attached to surround an aperture 23. The entering air flow 13 can therefore pass through the filter elements 20 prior to passing through the apertures 23 and exiting the filter section 18. After exiting the filter section 18, the air can pass through the outlet section 24 and through the outlet 25, whereupon the air exits the outlet 25 as exiting air flow 26.

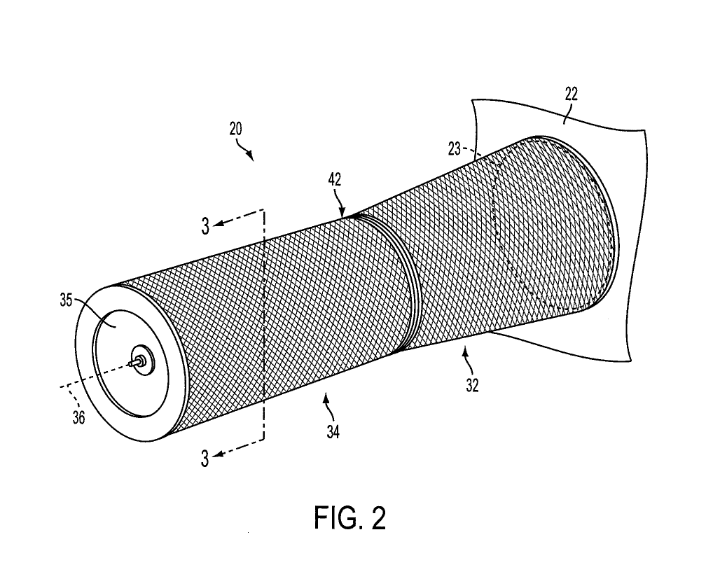

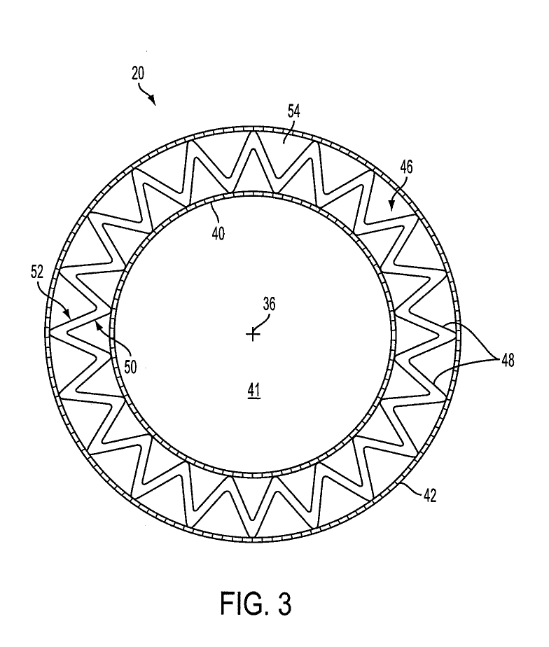

Referring now to FIGS. 2 and 3, the structure of an example filter element 20 can now be more fully described. As shown in FIG. 2, a single filter element is depicted attached to a section of the partition 22. It is to be understood that the filter element 20 and partition 22 are somewhat generically shown within FIG. 2, and could take on a variety of constructions in accordance with one or more aspects of the present invention. For instance, the remaining filter elements can be similar and/or identical to the filter element 20 in the shown example or, in the alternative, could take on a number of different sizes and shapes.

The example filter element 20 can include an elongated substantially cylindrically shaped structure having a conically shaped section 32. The conically shaped section 32 can include a truncated conical shape wherein a base of the conically shaped section 32 is attached to the partition 22. The base of the conically shaped section 32 can be attached to the partition 22 in a number of ways, including, but not limited to, adhesives, mechanical fasteners, snap fit means, or the like. As such, nearly any type of attachment structure can function to secure the conically shaped section 32 to the partition 22. The base of the conically shaped section 32 can have a diameter that substantially matches or is slightly larger than a diameter of the aperture 23 (shown only in phantom with FIG. 2, as aperture 23 is not normally visible in such a view). The conically shaped section 32 can be attached to the partition 22 at one end and can extend along a longitudinal axis 36 in a direction away from the partition 22. The conically shaped section 32 can be tapered in a direction along the longitudinal axis 36 away from the partition 22, such that the conically shaped section 32 has a gradually decreasing diameter.

The example filter element 20 further includes a cylindrically shaped section 34. The cylindrically shaped section 34 can be positioned adjacent to an end of the conically shaped section 32. The cylindrically shaped section 34 can extend coaxially with the conically shaped section 32 along the longitudinal axis 36. The cylindrically shaped section 34 can include a substantially constant diameter along the longitudinal axis 36. The cylindrically shaped section 34 can further include an end cap 35. The end cap 35 can function to seal an end of the cylindrically shaped section 34. The end cap 35 can be positioned at an end of the filter element 20 located opposite from the partition 22. The end cap 35 is shown to be circular in shape, though a variety of sizes and shapes are contemplated, such as polygonal shape, or the like. Accordingly, the end cap 35 can reduce and/or prevent the passage of air through the end of the filter element 20.

Referring now to FIG. 3, a cross-sectional view of the filter element 20 is shown. The filter element 20 can include a scrim 40. The scrim 40 defines a central passageway 41 formed within the filter element 20. The scrim 40 and the central passageway 41 can extend along the longitudinal axis 36. The longitudinal axis 36 extends in a substantially horizontal direction within the inlet system 10, such that the central passageway 41 and the scrim 40 also extend in a substantially horizontal direction. The scrim 40 can be substantially cylindrical in shape and/or could include both a cylindrical section and a conical section. For instance, in one example, the scrim 40 can include a substantially cylindrical shape, such as by having a constant diameter, along the length of the cylindrically shaped section 34. The scrim 40 could further include the substantially conical shape, such as by having a gradually increasing diameter, along the length of the conically shaped section 32. The scrim 40 could be made of a number of different metal materials, such as steel, titanium, a mesh-like wire material, or the like. In further examples, the scrim 40 could be made of a variety of non-metal materials, such as a number of different plastic materials. The scrim 40 may be sufficiently stiff to provide some support to the filter element 20, such that the scrim 40 functions as a support device. The scrim 40 can also be porous and include openings on the surface to allow for the passage of air through the scrim 40 to the central passageway 41. For instance, the scrim 40 may include a plurality of perforations, apertures, holes, etc. to allow air to pass from the exterior of the filter element 20 to the central passageway 41.

The filter element 20 can further include a support device 42. The support device 42 can extend concentrically about the scrim 40, substantially parallel to the scrim 40 and coaxial with the longitudinal axis 36. The support device 42 can have a larger diameter than the scrim 40, such that the support device 42 is spaced a radial distance from the scrim 40. The support device 42 can have a similar and/or identical shape as the scrim 40. For instance, the support device 42 can be substantially cylindrical in shape and/or could include the cylindrically shaped section 34 and the conically shaped section 32. For instance, in one example, the support device 42 can include the substantially cylindrical shape, such as by having a substantially constant diameter, along the length of the cylindrically shaped section 34. The support device 42 could further include the substantially conical shape, such as by having a gradually increasing diameter, along the length of the conically shaped section 32. The support device 42 could be made of a number of different metal materials, such as steel, titanium, a mesh-like wire material or the like, and may be sufficiently stiff to provide some support to the filter element 20. The support device 42 can be porous and include openings on the surface to allow for the passage of air through the support device 42 to the central passageway 41. For instance, the support device 42 may include a plurality of perforations, apertures, holes, etc. to allow air to pass from the exterior of the filter element 20 to the central passageway 41.

In further examples, the support device 42 may extend only partially along the longitudinal axis 36 from the end of the filter element 20 to the partition 22. Similarly, the support device 42 may include a single support device or a plurality of support devices. In this example, the support device 42 may comprise a retaining strap, band, or the like, that extends only a partial distance along the longitudinal axis 36. A plurality of support devices (i.e., retaining straps, bands, or the like) can be provided at spaced apart distances along the longitudinal axis 36.

Referring still to FIG. 3, the filter element 20 can further include a filter media 46. The filter media 46 can be arranged along a tubular orientation to circumferentially encircle the central passageway 41. The filter media 46 can be arranged between the scrim 40 and the support device 42. The filter media 46 can be limited and/or prevented from radial inward movement into the central passageway 41 by the scrim 40. Similarly, the filter media 46 can be limited and/or prevented from radial outward movement away from the central passageway 41 by the support device 42. The filter media 46 can be attached to either or both of the scrim 40 and the support device 42 such that the filter media 46 can, be supported therebetween. For instance, the filter media 46 can be attached to the scrim 40 and the support device 42 by an adhesive, such that the filter media 46 can be relatively non-movably secured therebetween. The filter media 46 can include an inner surface 50 and an outer surface 52. In the shown examples, a portion of the inner surface 50 engages, is attached to, and/or is adjacent to the scrim 40 at the radially inward extent of the filter media 46. Similarly, a portion of the outer surface 52 engages, is attached to, and/or is adjacent to the support device 42 at the radially outward extent of the filter media 46.

The filter media 46 can be provided with or without the scrim 40 and support device 42. For instance, in further examples, the filter media 46 can be provided without the scrim 40 and/or the support device 42, such that the filter media 46 can be self-supporting. In such an example, without the scrim 40 and the support device 42, the inner surface 50 will define the inner-most surface of the filter element 20 while the outer surface 52 will define the outer-most surface of the filter element 20.

The filter media 46 can include a plurality of pleats 48 that are elongated parallel to the longitudinal axis 36. The pleats 48 can extend in a substantially zig-zag pattern radially toward and away from the longitudinal axis 36. For instance, in a circumferential direction around the longitudinal axis 36 and central passageway 41, the pleats 48 can alternately project inwardly towards the longitudinal axis 36 then project outwardly away from the longitudinal axis 36. The pleats 48 can further define a trough portion 54 formed between the outer surfaces 52 of adjacent pleats. Specifically, the trough portion 54 can be formed between adjacent locations where the pleats 48 project outwardly away from the longitudinal axis 36. The trough portion 54 can form a channel, drain, or the like between the outer surfaces 52 of adjacent pleats. As such, the trough portion 54 can extend along the length of the filter element 20 and along the longitudinal axis 36 with the pleats 48.

The filter media 46 can be formed of a number of different materials. For instance, the filter media 46 can include a variety of filtering materials that function to remove particulates from air that passes through the filter media 46. The filter media 46 can further include a hydrophobic media. In further examples, the filter media 46 could include a layer or coating of hydrophobic media deposited on either or both of the inner surface 50 and outer surface 52. In one example, the filter media 46 can include polytetrafluoroethylene (PTFE) or expanded polytetrafluoroethylene (ePTFE). However, a variety of materials are contemplated that can function to limit and/or prevent the passage of liquid through the filter media 46. As such, the filter media 46 can reduce and/or prevent the passage of target particulates from air while simultaneously reducing and/or preventing the passage of liquid through the filter media 46. In these examples, the filtered particulates and the liquid can accumulate on the outer surface 52, such as in the trough portion 54.

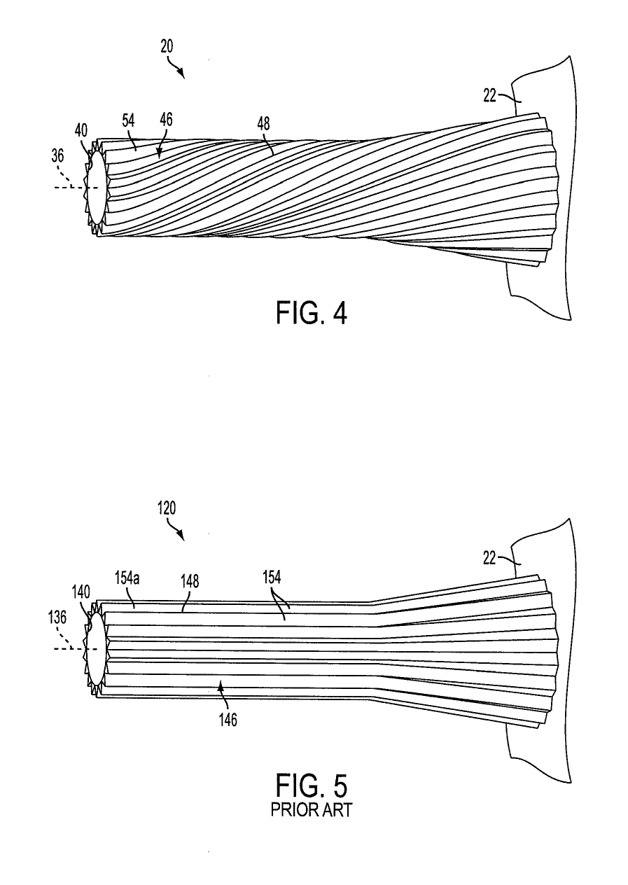

Referring now to FIG. 4, the filter element 20 is shown with the end cap 35 and support device 42 removed for illustrative purposes and for clarity. The filter media 46 can be arranged on the scrim 40 extending along the longitudinal axis 36. Specifically, the pleats 48 of the filter media 46 can be arranged to extend in a substantially helical orientation with respect to the longitudinal axis 36. In the substantially helical orientation, the pleats 48 can extend clockwise or counterclockwise around the scrim 40, longitudinal axis 36 and central passageway 41 in a winding/twisting configuration. The pleats 48 can rest on and wind around the scrim 40 in an encircling configuration. Similarly, the pleats 48 can have varying pitches (i.e., width or distance along a direction of the longitudinal axis 36 for the pleats 48 to make a complete 360° helical turn around the scrim 40). For instance, the pleats 48 can have a smaller pitch than in the shown example, such that the pleats 48 can form more full turns around the scrim 40. In the alternative, the pleats 48 can have a larger pitch than as shown, such that the pleats 48 can form fewer full turns around the scrim 40. As the pitch of the pleats 48 increases, the pleats 48 will have less of a helical twisting orientation and can be straighter. Accordingly, the substantially helical orientation of the filter media 46 can also include an identical concurrent helical orientation of the trough portion 54.

Due to the substantially helical orientation of the pleats 48, the pleats 48 will wind around the longitudinal axis 36 with respect to the scrim 40 and support device 42 from a first end to a second end of the filter element 20. As such, each of the pleats 48 and trough portions 54 can be positioned at varying locations around the longitudinal axis 36. For instance, at one location, one of the trough portions can be positioned at a top surface of the filter element 20. However, at a second location along the longitudinal axis 36 that is different from the first location, the same trough portion could be positioned at a side surface or a bottom surface of the filter element 20 due to the winding helical orientation of the pleats 48. Accordingly, each of the pleats 48 and trough portions 54 may not extend solely longitudinally along the filter element 20 and may not have a static position (i.e., only along the top surface, side surface, bottom surface, etc.) along the length of the filter element 20. The degree of helical rotation of each of the pleats 48 and trough portions 54 can be varied and is not limited to the shown example. For instance, it is to be understood that the pleats 48 and trough portions 54 can extend around the longitudinal axis 36 in the helical orientation in a range of at least about 90 degrees of rotation to about a maximum of 360 degrees of rotation along an entire length of the filter element 20 (i.e., first end to an opposing second end).

It is to be understood that in further examples, the pleats 48 can extend in a variety of non-linear orientations with respect to the longitudinal axis 36. For instance, the pleats 48 and trough portion 54 can include rotating, twisting, crisscrossing, zig-zagging, and/or curving around the scrim 40 and the longitudinal axis 36, and are not limited to the helical orientation. For instance, in one example, the pleats 48 and trough portion 54 could extend circularly around the scrim 40 and the longitudinal axis 36, such that each of the pleats 48 and trough portions 54 extend about the longitudinal axis 36 in a direction that is perpendicular to the longitudinal axis 36. As such, the orientation of the pleats 48 and trough portion 54 in the shown example is not intended to be limiting on further embodiments. Furthermore, while the examples shown in FIGS. 4 and 5 include the filter media 46 as a single filter media provided around both the conically shaped section 32 and cylindrically shaped section 34, it is to be understood that the filter media 46 could include two separate filter media. In such an example, the conically shaped section 32 could include a first filter media while the cylindrically shaped section 34 could include a second filter media that is different and separate from the first filter media.

The operation of the filter element 20 can now be described. Referring first to FIG. 1, entering air flow 13 can enter the inlet system 10 through the inlet section 14. The entering air flow 13 can pass through the inlet section 14 and into the filter section 18. In the filter section 18, air can pass through the filter elements 20, causing the air to be filtered by the filter elements 20.

Referring now to FIGS. 3 and 4, the filter element 20 operation can be described in more detail. Air can be filtered by passing through the support device 42, the filter media 46, and then the scrim 40. The air can pass through the openings of each of the support device 42 and the scrim 40. The air passing through the filter media 46 is filtered due, at least in part, to the hydrophobic and filtering capabilities of the filter media 46. As such, particles and liquid can be limited and/or prevented from passing through the filter media 46. During this filtering process, the particles and liquid can accumulate on the outer surface 52 of the pleats 48 while the cleaned/filtered air passes through the scrim 40 and into the central passageway 41. The cleaned/filtered air can pass through the filter elements 20 and exit the filter section 18 through the apertures 23. The air can then pass through the outlet section 24 and exit the inlet system 10 through the outlet 25.

The liquid that has been filtered by the filter media 46 can collect in the trough portions 54 between adjacent pleats. Due at least in part to the helical orientation of the pleats 48, trough portions 54 can extend around the longitudinal axis 36 in a substantially circular orientation. Accordingly, the trough portions 54 will not extend solely along a static position (i.e., only along the top surface, side surface, bottom surface, etc.) of the filter element 20. For example, the trough portions 54 may each be positioned at a top surface of the filter element, but may helically rotate to be positioned at side surface and/or a bottom surface of the filter element along the longitudinal axis 36. As such, liquid that accumulates at or near the top surface within the trough portions 54 can naturally drain from the top surface under the influence of gravity, such as by flowing through the trough portions 54 down the sides of the filter element 20. The helical orientation of the pleats 48 therefore will reduce and/or prevent water from accumulating within the trough portions 54.

By allowing the liquid to drain from the trough portions 54 and not accumulate, the filter element 20 can exhibit a number of benefits. For instance, the filter element 20 can have an improved efficiency due to a larger effective filtering surface area, such that more air can be filtered. Further, pressure drop can also be decreased across the filter media 46 as well, since less water will accumulate in the trough portions 54. Even further, by limiting and/or preventing the accumulation of water within the trough portions 54, the filter element 20 can exhibit a longer life due to less wear. Wear can occur, at least in part, due to the accumulation of water along a top surface and top-side surfaces. Accordingly, the liquid that drains from the filter element 20 can fall from the filter element 20 under the influence of gravity towards the bottom of the filter section 18. The filter section 18 can include a drain, collection apparatus, or the like (not shown) for collecting the liquid that falls from the filter elements.

Referring now to FIG. 5, an example of a filter element 120 in accordance with the prior art is shown. The filter element 120 can include a support device (not shown) and a scrim. The filter element 120 can further include a filter media 146 having a plurality of pleats 148. The filter media 146 can be made of a variety of filtering materials including hydrophobic filtering materials. The pleats 148 are arranged longitudinally, such that the pleats are substantially parallel to a longitudinal axis 136 of the filter element 120. Trough portions 154 can be formed between adjacent pleats, such that the trough portions 154 extend longitudinally along the longitudinal axis 136. In operation, the filter element 120 can filter particles and liquid from air that passes through the filter media 146. The liquid can accumulate in the trough portions 154. However, due to the horizontal orientation of the filter element 120 and the longitudinal orientation of the trough portions 154, liquid that accumulates in a top trough portion 154a at a top surface of the filter element 120 is reduced and/or prevented from draining from the filter element 120. As such, liquid will build up within upward facing pleats, such as the top trough portion 154a and in adjacent trough portions at or near the top surface of the filter element 120. This liquid buildup can limit and/or prevent air flow through the filter element 120 at the upper portions (i.e., at locations where the liquid has pooled within a trough portion). Further, the liquid buildup can cause a relatively high pressure drop across the filter element. Accordingly, the filter element 20 of the present invention having helically oriented pleats can reduce the aforementioned drawbacks of the prior art filter element.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A filter element comprising:
a filter media extending along a longitudinal axis and circumferentially about a central passageway that extends along the longitudinal axis, the filter media being configured to have a plurality of pleats, wherein the pleats extend in a helical orientation about the longitudinal axis.

2. The filter element of claim 1, further including a scrim located radially within the filter media to prevent radial inward movement of the filter media into the central passageway.

3. The filter element of claim 2, further including a support device located radially outside the filter media to prevent radial outward movement of the filter media.

4. The filter element of claim 1, wherein the longitudinal axis extends along a substantially horizontal direction.

5. The filter element of claim 4, wherein the plurality of pleats define a plurality of trough portions extending between adjacent pleats, the plurality of trough portions being configured to extend around the longitudinal axis in the helical orientation.

6. The filter element of claim 5, wherein each of the trough portions is configured to extend in the helical orientation from a first end of the filter element to an opposing second end of the filter element such that one of the trough portions is positioned at a top surface of the filter element at a first location along the longitudinal axis and a bottom surface of the filter element at a second location along the longitudinal axis, further wherein the plurality of trough portions are configured to extend around the longitudinal axis in the helical orientation in a range of at least about 90 degrees of rotation to about a maximum of 360 degrees of rotation between the first end and the second end of the filter element.

7. The filter element of claim 6, wherein the plurality of pleats includes a hydrophobic material.

8. The filter element of claim 7, wherein the plurality of pleats is configured to filter air and liquid passing through the plurality of pleats.

9. The filter element of claim 8, wherein the liquid is configured to drain from the top surface by flowing through the trough portions under the influence of gravity.

10. A filter element comprising:
a support device extending circumferentially along a longitudinal axis about a central passageway; and
a filter media positioned on the support device and extending along the longitudinal axis circumferentially about the central passageway, the filter media being configured to have a plurality of pleats, wherein at least one the pleats extends in a non-linear orientation about the longitudinal axis.

11. The filter element of claim 10, wherein the support device includes a scrim located radially within the filter media to prevent radial inward movement of the filter media into the central passageway.

12. The filter element of claim 11, wherein the plurality of pleats define a plurality of trough portions extending between adjacent pleats, the trough portions being configured to extend around the scrim in the non-linear orientation.

13. The filter element of claim 12, wherein the plurality of pleats is configured to filter air and liquid passing through the plurality of pleats such that the liquid is configured to drain from a top surface of the filter element through the trough portions under the influence of gravity.

14. The filter element of claim 13, wherein the plurality of pleats is configured to extend in a helical orientation about the longitudinal axis.

15. A filter element comprising helically oriented pleats.

16. The filter element of claim 15, comprising:
a filter media extending along a longitudinal axis and circumferentially about a central passageway that extends along the longitudinal axis, the filter media being configured to include the helically oriented pleats, the pleats extending in the helical orientation about the longitudinal axis,
wherein the longitudinal axis extends along a substantially horizontal direction within a gas turbine system.

17. The filter element of claim 16, wherein the plurality of pleats includes a hydrophobic material.

18. The filter element of claim 17, wherein the plurality of pleats define a plurality of trough portions, one of the trough portions being positioned at a top surface of the filter element at a first location along the longitudinal axis and a bottom surface at second location along the longitudinal axis, further wherein the plurality of trough portions are configured to extend around the longitudinal axis in the helical orientation in a range of at least about 90 degrees of rotation to about a maximum of 360 degrees of rotation along an entire length of the filter element

19. The filter element of claim 18, wherein the plurality of pleats is configured to filter air passing through the pleats and reduce the passage of liquid through the pleats.

20. The filter element of claim 19, wherein the liquid is configured to accumulate in the trough portions, further wherein the liquid is configured to drain from a top surface of the filter element through the trough portions.
